(19) United States
(12) Patent Application Publication
(10) Pub. No.: US 2016/0300248 A1
(43) Pub. Date: Oct. 13, 2016

(54) SERVER AND METHOD FOR ACQUIRING ATTRIBUTE INFORMATION

(71) Applicant: TOSHIBA TEC KABUSHIKI KAISHA, Tokyo (JP)

(72) Inventor: Masachika Kurata, Mishima (JP)

(21) Appl. No.: 15/091,657

(22) Filed: Apr. 6, 2016

(30) Foreign Application Priority Data
Apr. 7, 2015 (JP) 2015-078549

(51) Int. Cl. G06Q 30/02

(52) U.S. Cl. CPC G06Q 30/0201

(57) ABSTRACT

In accordance with an embodiment, a server comprises a storage section configured to store an attribute ratio representing the ratio of attributes of people who purchased a sales object in the past in association with sales object information specifying the sales object, a reception module configured to receive the sales object information of the sales object purchased by a customer from a sales data processing apparatus which carries out a transaction processing of the sales object, and an attribute acquisition module acquires an attribute of which the attribute ratio is highest among the attribute ratios which are stored in the storage section and correspond to the sales object information received by the reception module.

### CROSS-REFERENCE TO RELATED APPLICATION

This application is based upon and claims the benefit of priority from Japanese Patent Application No. 2015-078549, filed Apr. 7, 2015, the entire contents of which are incorporated herein by reference.

### FIELD

Embodiments described herein relate generally to a server and a method for acquiring attribute information.

### BACKGROUND

In a store such as a convenience store, there is a case in which attribute information indicating an attribute such as gender, age bracket and the like of a customer who purchases commodities is acquired to carry out clientele analysis, commodity sales analysis and the like. The attribute information of the customer who executes a transaction is acquired by analyzing an image of the customer captured by a camera arranged on a POS (Point of Sales) terminal or a ceiling.

Incidentally, it is necessary to photograph the face of the customer from the front of the customer so that the attribute information is obtained from the image of the customer. However, in a case in which the customer does not face the camera directly, or in a case in which the customer wears a mask or hat even if he/she faces the camera directly, there is a possibility that the attribute information of the customer cannot be acquired.

### DESCRIPTION OF THE DRAWINGS

FIG. 1 is a diagram schematically illustrating a system according to an embodiment;

FIG. 2 is a planar schematic diagram illustrating a state in which a POS terminal of the embodiment is arranged inside a store when viewed from the upper side;

FIG. 3 is a perspective diagram illustrating the appearance of the POS terminal of the embodiment when viewed from the customer side;

FIG. 4 is a block diagram illustrating the hardware structure of the POS terminal;

FIG. 5 is a memory map illustrating an example of a face master file in the POS terminal;

FIG. 6 is a block diagram illustrating the hardware structure of a server;

FIG. 7 is a memory map illustrating an example of an attribute storage section of the server;

FIG. 8 is a flowchart illustrating the flow of a control processing of the POS terminal;

FIG. 9 is a flowchart illustrating the flow of a control processing of the POS terminal;

FIG. 10 is a flowchart illustrating the flow of a control processing of the POS terminal;

FIG. 11 is a functional block diagram illustrating the functional components of the server;

FIG. 12 is a flowchart illustrating the flow of a control processing of the server;

FIG. 13 is a diagram illustrating graphed data stored in the attribute storage section of the server;

FIG. 14 is a diagram illustrating graphed data stored in the attribute storage section of the server; and

FIG. 15 is a diagram illustrating graphed data stored in the attribute storage section of the server.

### DETAILED DESCRIPTION

In accordance with an embodiment, a server comprises a storage section configured to store an attribute ratio representing the ratio of attributes of people who purchased a sales object in the past in association with sales object information specifying the sales object, a reception module configured to receive the sales object information of the sales object purchased by a customer from a sales data processing apparatus which carried out a transaction processing of the sales object, and an attribute acquisition module configured to acquire an attribute of which the attribute ratio is highest among the attribute ratios which are stored in the storage section and correspond to the sales object information received by the reception module.

In accordance with the embodiment, a method used to enable a computer to control a server which includes a storage section configured to store an attribute ratio representing the ratio of attributes of people who purchased a sales object in the past in association with sales object information specifying the sales object, causes the computer to function as a reception module configured to receive the sales object information of the sales object purchased by a customer from a sales data processing apparatus which carried out a transaction processing of the sales object and an attribute acquisition module configured to acquire an attribute of which the attribute ratio is highest among the attribute ratios which are stored in the storage section and correspond to the sales object information received by the reception module.

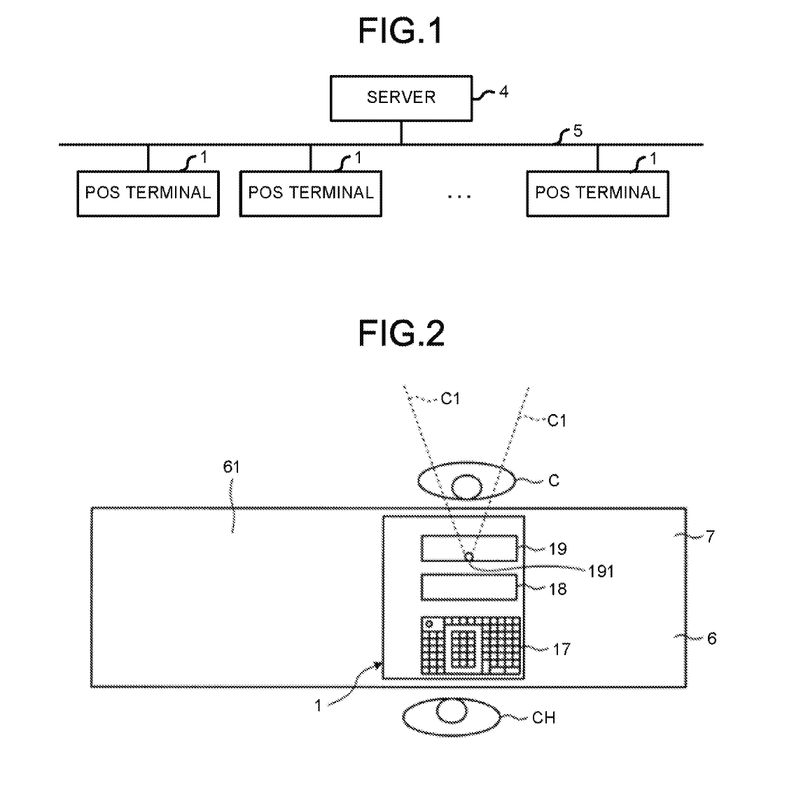

Hereinafter, the server and the method for acquiring attribute information according to the embodiment are described in detail with reference to FIG. 1-FIG. 15. In the present embodiment, a commodity is described as an example of the sales object. Moreover, this invention is not limited by the embodiment described below.

FIG. 1 is a diagram schematically illustrating a system of an embodiment. The system consists of a plurality of POS (Point of Sales) terminals 1 that are arranged in a store and a server 4.

Each of the plurality of POS terminals 1 is arranged in a commodity sales floor in the store. Each POS terminal 1 is electrically connected with the server 4 via a communication line 5 such as a LAN (Local Area Network).

The POS terminal 1 carries out a sales registration processing relating to sales of commodities sold in the store. An operator CH (store clerk) operates the POS terminal 1, and thus the POS terminal 1 executes a sales registration processing and a settlement processing on the sold commodities. The sales registration processing refers to a processing of reading a code symbol optically such as a barcode attached to a sold commodity, inputting the commodity code and displaying a commodity name and a price (commodity information) of the commodity read based on the input commodity code, and storing the commodity information in a buffer. The settlement processing refers to, based on the commodity information stored in the buffer at the time of the sales registration processing, a processing of displaying a total amount relating to this transaction and calculating and displaying a change amount according to a deposit amount prepaid by the customer, a processing of instructing a change dispensing machine to issue the change amount and a processing of issuing a receipt on which the commodity information and settlement information (the total amount, the deposit amount, the change amount, etc.) are printed. Furthermore, a processing in which the sales registration processing and the settlement processing are combined is referred to as a transaction processing.

The server 4 is electrically connected with all the POS terminals 1 via the communication line 5. The server 4 totalizes the commodity information (sales object information) and the settlement information of the sold commodities with the POS terminals 1 and stores the totalized information. The server sends the commodity information and the settlement information collected from the POS terminals 1 to a headquarters server (not shown) that is arranged in the headquarters.

The server 4 stores, in association with commodity information (for example, a commodity code specifying a commodity) indicating the sold commodity, an attribute ratio indicating the purchase rate of the commodity by each attribute (gender, age bracket and the like) of people who purchase the commodity.

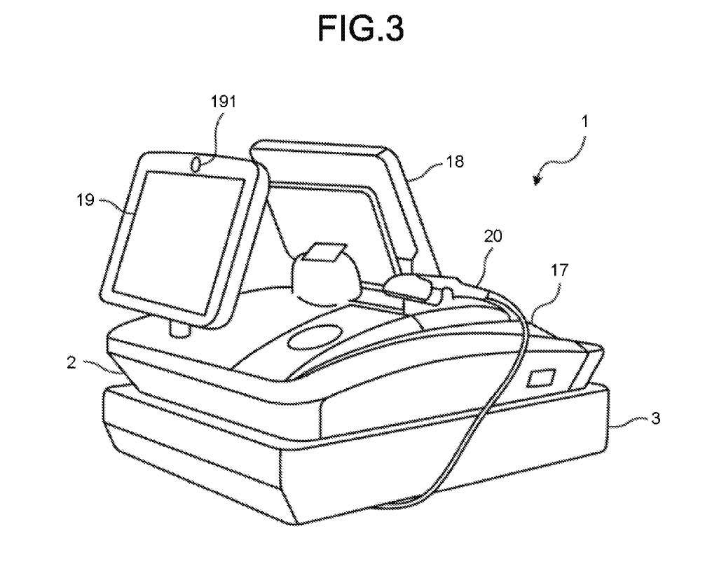

FIG. 2 is a planar schematic diagram illustrating the POS terminal 1 arranged in the store. A settlement location is arranged in the store to settle the commodities displayed in the store. FIG. 2 illustrates one of a plurality of rectangular counters 6 in the settlement location. A flat plane 7 where the POS terminal 1 is arranged is formed on the top surface of this counter 6. The operator CH is positioned at the operation side of the POS terminal 1, and a customer C is positioned at the passage side which is opposite to the operation side across the counter 6. The customer C places a basket in which a commodity to be purchased is put on a placing section 61 of the counter 6. The operator CH takes out the commodity from the basket placed on the placing section 61, and optically reads a code symbol attached to the commodity with a reading section 20 (refer to FIG. 3). In this way, the POS terminal 1 executes the sales registration processing and the settlement processing on the commodity.

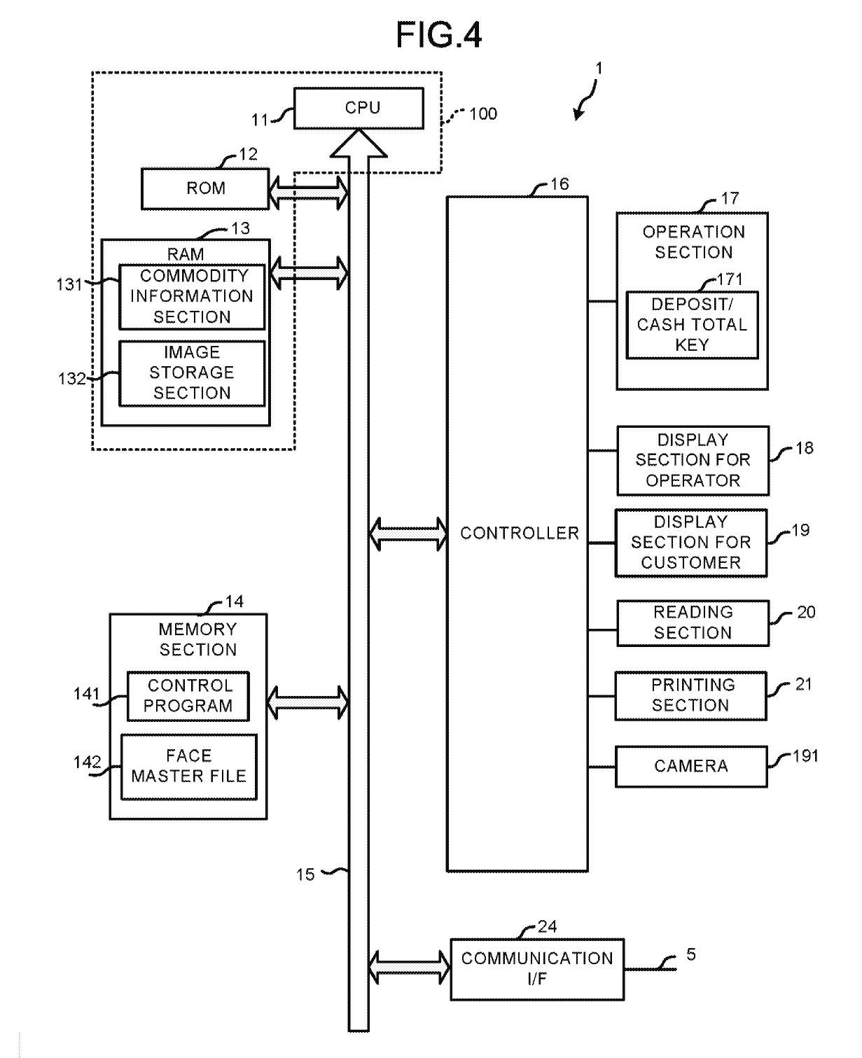

The POS terminal 1, which will be described in detail with reference to FIG. 3 and FIG. 4, comprises an operation section 17 such as a keyboard operated by the operator CH, a display section 18 for operator for displaying information to the operator CH and a display section 19 for customer for displaying information to the customer C.

A camera 191 is arranged on the upper part of the outer frame of the display section 19 for customer. The camera 191 is composed of a CCD (Charge Coupled Device) image sensor and the like. The camera 191 is arranged to be directed to the customer C, and is arranged at a position where the customer C (who positions in an area surrounded by C1 at the customer C side of the POS terminal 1) can see the display displayed on the display section 19 for customer.

The camera 191 captures a motion image or continuous still images (collectively referred to as “image”) of the customer C who executes a transaction by taking the face of the customer C as a center and also including the surroundings. In the present embodiment, the camera 191 captures, for example, 10 images of the customer C in one second.

FIG. 3 is a perspective view illustrating the appearance of the POS terminal 1 of the embodiment when viewed from the customer C side. In FIG. 3, the POS terminal 1 includes a main body 2 and a cash box 3. The cash box 3 with a drawer stores cash such as bills and coins and marketable securities such as a gift voucher received from the customer C, and change to be handed over to the customer C.

The main body 2 includes the operation section 17 for inputting information, the display section 18 for operator used to display information to the operator, e.g., a liquid crystal display, and the display section 19 for customer used to display information to the customer C, e.g., a liquid crystal display. Further, the main body 2 is provided with the reading section 20 to read a code symbol such as a barcode, a two-dimensional code and the like attached to the commodity. The reading section 20 reads and inputs the code attached to the commodity with the CCD image sensor. Inside the main body 2 is also equipped with a control section 100 (refer to FIG. 4) of the POS terminal 1 and a printing section 21 which is used for printing commodity information and issuing a receipt.

Furthermore, the camera 191 is arranged at the center of the upper part of the display surface side of the display section 19 for customer of the POS terminal 1.

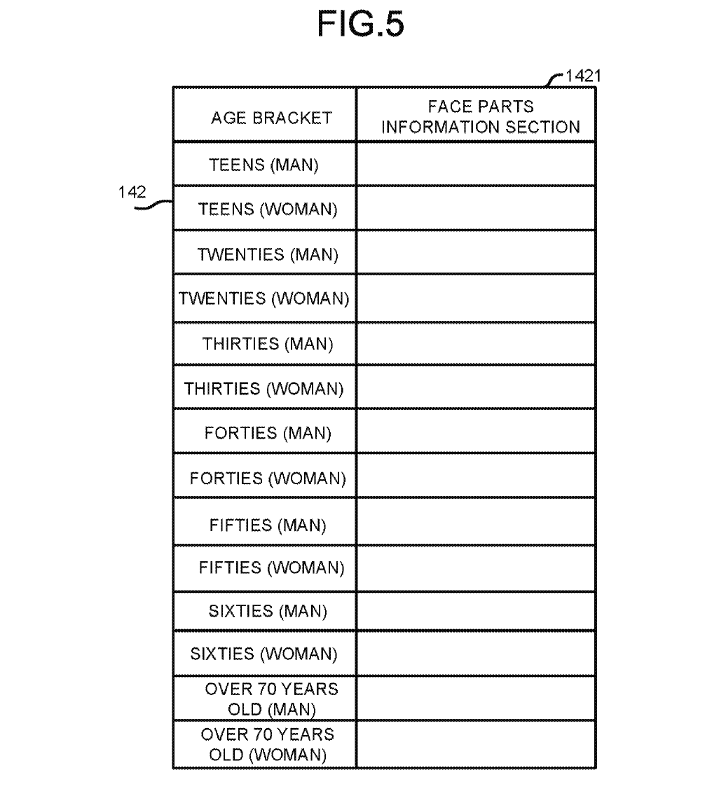

Next, the hardware of the POS terminal 1 is described with reference to FIG. 4 and FIG. 5. FIG. 4 is a block diagram illustrating the hardware structure of the POS terminal 1. In FIG. 4, the POS terminal 1 comprises a CPU (Central Processing Unit) 11, a ROM (Read Only Memory) 12, a RAM (RandomAccess Memory) 13, a memory section 14 and the like. The CPU 11 acts as a main part of control. The ROM 12 stores various kinds of programs. The RAM 13 copies or decompresses programs and various data. The memory section 14 stores various kinds of programs. The CPU 11, the ROM 12, the RAM 13 and the memory section 14 are connected with each other via a data bus line 15. The CPU 11, the ROM 12 and the RAM 13 constitute the control section 100. That is, the CPU 11 operates according to a control program 141 stored in the ROM 12 or the memory section 14 and copied or decompressed on the RAM 13, and in this way, the control section 100 executes a control processing described later.

The RAM 13 comprises a commodity information section 131 and an image storage section 132. The commodity information section 131 stores commodity information (commodity code, commodity name, price and the like) of a commodity, corresponding to the commodity code read by the reading section 20, to which the sales registration processing is carried out. The image storage section 132 stores an image of the customer C whose the face is detected from an image captured by the camera 191. A face detection technology for detecting the face is a well-known technology for detecting a face of a person by detecting all under-mentioned parts (eyes, nose, mouth, ears, jaw and the like) of a face from the image captured by the camera 191.

The memory section 14, which is a non-volatile memory such as an HDD (Hard Disc Drive) or a flash memory in which the storage information is held even if the power supply is cut off, stores programs including the control program 141. The memory section 14 also comprises a face master file 142 (refer to FIG. 5)

The operation section 17, the display section 18 for operator, the display section 19 for customer, the reading section 20, the printing section 21 and the camera 191 are connected to the data bus line 15 via a controller 16. The controller 16 receives an instruction from the control section 100 to control the operation section 17, the display section 18 for operator, the display section 19 for customer, the reading section 20, the printing section 21 and the camera 191. To simply the description, the control operation carried out by the controller 16 is only described as that carried out by the control section 100.

The operation section 17 comprises various keys including numeric keys, function keys and the like. A subtotal key (not shown) is operated to declare the start of a settlement processing after a sales registration processing on a purchased commodity is ended. If the subtotal key is operated, the settlement processing of this transaction is started. The deposit/cash total key 171 is used for performing a settlement processing on the transaction with cash while declaring the end of the transaction. If the deposit/cash total key 171 is operated, a settlement processing with cash is executed.

The display surface of the display section 18 for operator is arranged to direct to the operator CH to display information to the operator. The display surface of the display section 19 for customer is arranged to direct to the customer C to display information to the customer C. Touch keys (not shown), which are arranged on the display section 18 for operator and the display section 19 for customer and can be touched to play a role of keys, are part of the operation section 17.

The reading section 20, which is constituted by the CCD image sensor, reads a code symbol such as a barcode or a two-dimensional code attached to the commodity with the CCD image sensor, and inputs the read commodity code. In the embodiment, the operator closes or contacts the hand-held reading section 20 to or with the code symbol attached to a commodity to read the code symbol. Further, the reading section 20 may be a scanner which emits light to scan the code symbol with a polygonal mirror and the like and receives the light reflected from the code symbol.

The printing section 21 includes, for example, a thermal printer provided with a thermal transfer type print head. The printing section 21 takes out a rolled receipt paper housed in the main body 2 and prints commodity information and settlement information on the receipt paper to issue the printed paper as a receipt. The camera 191, which is constituted by a CCD, captures an image of the customer C who executes a transaction by taking the face of the customer C as a center and including the surroundings. In the present embodiment, 10 images of the customer C are continuously captured in one second, for example.

Further, the data bus line 15 connects with a communication I/F (Interface) 24 that is electrically connected with the server 4 arranged in the store. The communication I/F 24 is connected to the communication line 5. The server 4 is electrically connected with all the POS terminals 1 arranged in the store to collect commodity information and settlement information from these POS terminals 1. The store server sends the commodity information and the settlement information collected from the POS terminals 1 to the headquarters server (not shown) that is arranged in the headquarters.

FIG. 5 is a memory map illustrating the face master file 142 of the memory section 14. In FIG. 5, the face master file 142 comprises face parts information sections 1421 storing face part information for each gender/each age bracket from teens to over 70 years old. Each face parts information section 1421 stores the face part information which can specify the attributes (age bracket and gender) respectively.

The face part information refers to data, obtained by classifying a human face in accordance with parts and features, which indicates each part and feature of each attribute, for example, data representing features of parts containing eyes, nose, mouth, ears, and jaw of a person and facial deformation features containing a smiling face, a solemn face, a face with closed eyes and a face with opened eyes. The face part information stored by each attribute represents features of the attribute different from other attributes. For example, in a face parts information section 1421 of males in their teens, information of eyes, nose, mouth and ears indicating the features of males in their teens and information of a smiling face and a solemn face indicating the features of males in their teens are stored. The face part information stored by this attribute is created based on a large amount of statistical data can represent the attribute markedly.

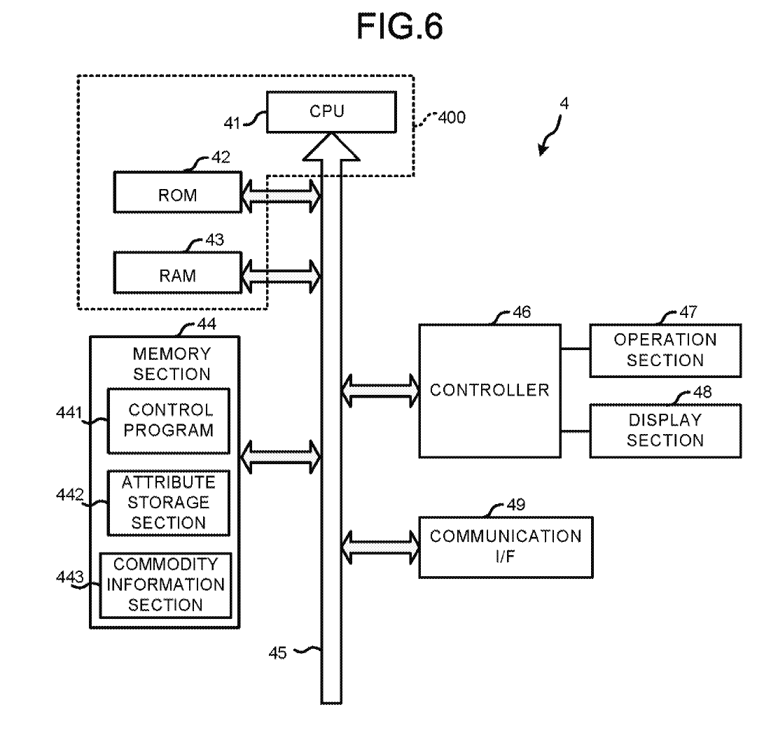

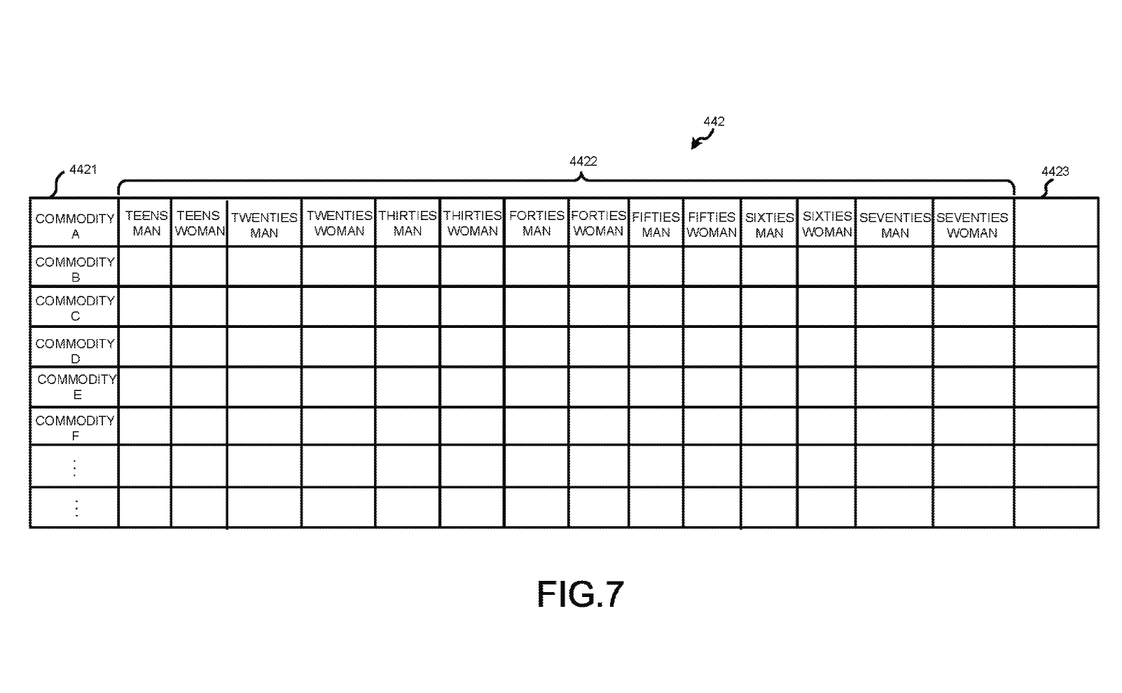

Next, the hardware of the server 4 is described with reference to FIG. 6 and FIG. 7. FIG. 6 is a block diagram illustrating the hardware structure of the server. In FIG. 6, the server 4 comprises a CPU 41 serving as a main part of control, a ROM 42 for storing various kinds of programs, a RAM 43 on which various data are copied or decompressed, a memory section 44 for storing various kinds of programs and the like. The CPU 41, the ROM 42, the RAM 43 and the memory section 44 are connected with each other via a data bus line 45. The CPU 41, the ROM 42 and the RAM 43 constitutes the control section 400. That is, the CPU 41 operates according to a control program 441 stored in the ROM 42 or the memory section 44 and copied or decompressed on the RAM 43, and in this way, the control section 400 executes a control processing described later.

The memory section 44, which is a non-volatile memory such as an HDD (Hard Disc Drive) or a flash memory in which the storage information is held even if the power supply is cut off, stores programs including the control program 441. The memory section 44 also comprises an attribute storage section 442 (refer to FIG. 7) and a commodity information section 443. The commodity information section 443 stores commodity information relating to inquiry about attributes and received from the POS terminals 1.

Furthermore, an operation section 47 and a display section 48 are connected to the data bus line 45 via a controller 46. The operation section 47 is a keyboard which comprises keys for performing various operations. For example, the display section 48 which is a liquid crystal display displays information. A communication I/F 49 is connected to the data bus line 45. The communication I/F 49 is electrically connected to the POS terminal 1 through the communication line 5.

Next, the attribute storage section 442 is described with reference to FIG. 7. The attribute storage section 442 totalizes the commodity information of commodities (that is, commodities purchased by the customer C) to which the sales registration processing is carried out with the POS terminal 1 in association with the attributes of the customer C who purchases the commodities by each attribute (gender, age bracket, etc.) and stores the commodity information and the attributes. Based on the commodity information stored in the attribute storage section 442, it is possible to analyze the tendency or trend of customers to purchase commodities with different attributes.

The attribute storage section 442 comprises a commodity information section 4421, an attribute ratio section 4422 and an unknown information section 4423. The commodity information section 4421 stores commodity codes for specifying the commodities purchased by the customer C. The attribute ratio section 4422 stores attribute ratios for each attribute corresponding to the commodity codes respectively.

The attribute ratio section 4422 stores an attribute ratio indicating the purchase rate of a sold commodity by an attribute of people who purchase the commodity corresponding to the commodity code indicating the commodity. Specifically, the attribute ratio section 4422 stores purchase quantity of the commodity by the attribute of people who purchase the commodity corresponding to the commodity code indicating the sold commodity. Then, the attribute ratio section 4422 stores the rate (attribute ratio) obtained by dividing the purchase quantity of a commodity by each attribute by the total purchase quantity of the commodity.

For example, the attributes of people who purchase a commodity A are stored as follows: the rate of males in their twenties is 20%, the rate of females in their twenties is 25%, the rate of males in their thirties is 10%, the rate of females in their thirties is 15% . . . . The rates such as 20%, 25%, 10% and 15% serving as attribute ratios refer to the rate of each attribute among the people who purchase the commodity A. The attribute whose attribute ratio is higher represents that the purchase rate of the commodity is higher. That is, the attribute whose attribute ratio is high represents that the customer of the attribute purchases many of this commodity. The attribute ratios of a commodity B and a commodity C are also stored similarly.

Further, the attribute ratio section 4422 stores the quantity of unknown attributes by each attribute. The unknown attribute refers to, in a case in which the face of the customer C who purchases the commodities cannot be detected in a sales registration processing, the quantity of unknown attributes when the unknown information corresponding to the commodity information of the commodities purchased by the customer C and indicating that the attributes are unknown are received from the POS terminal 1.

In a case in which the unknown information and the commodity information are received from the POS terminal 1, the unknown information section 4423 stores the quantity of the received unknown information corresponding to the commodity information. The quantity of the received unknown information is increased by one every time the unknown information is received. Further, every time an under-mentioned attribute is extracted, the quantity of the received unknown information is decreased by one.

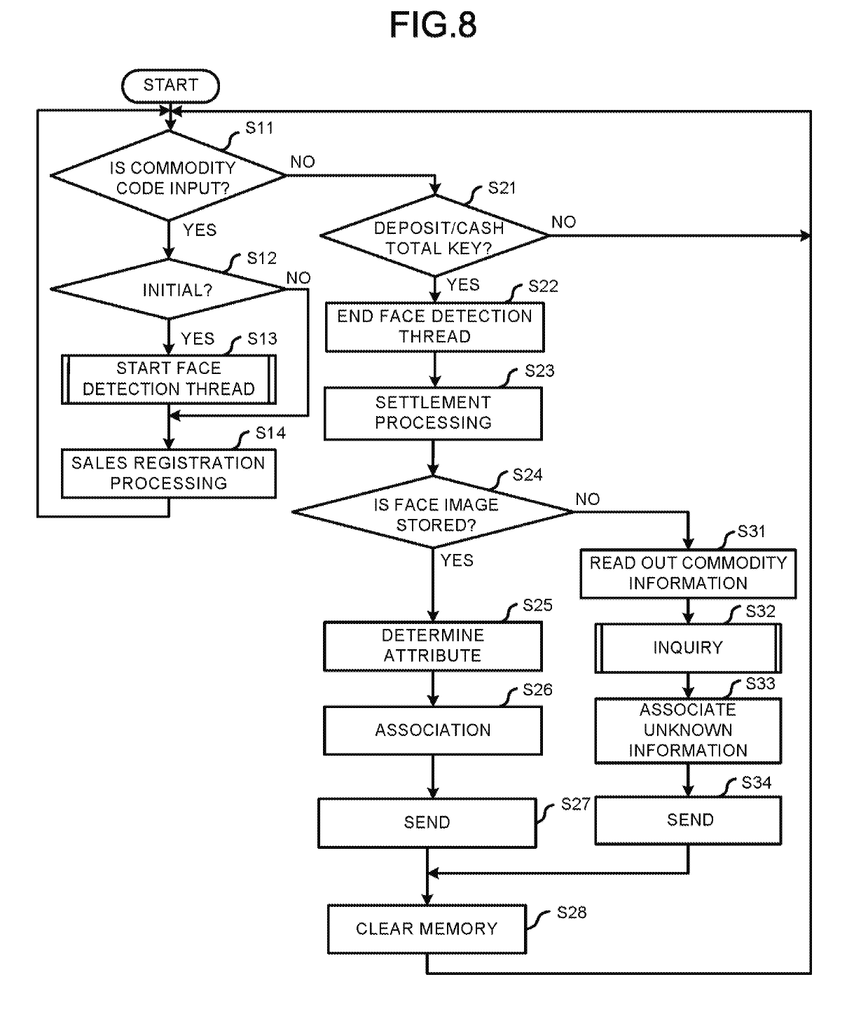

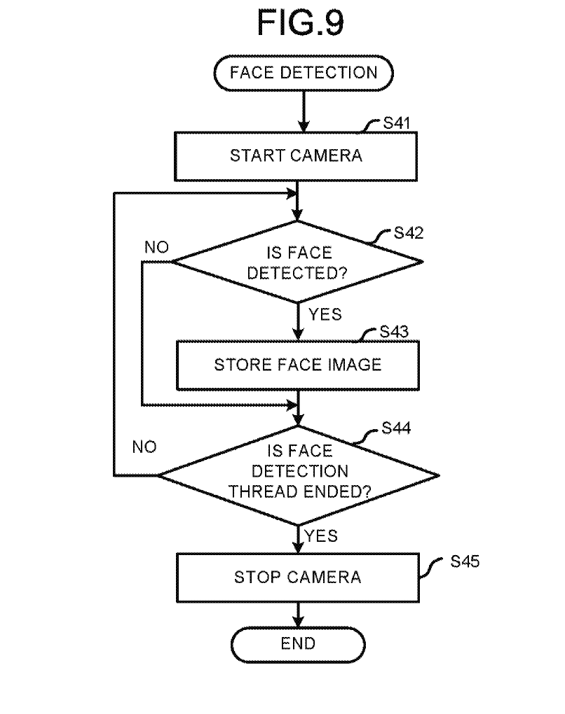

Next, the control processing of the POS terminal 1 is described with reference to FIG. 8 and FIG. 9. FIG. 8 is a flowchart illustrating the flow of the control processing of the POS terminal 1. First, in FIG. 8, the control section 100 determines whether or not a commodity code is input after a code symbol attached to a commodity is read by the reading section 20 (ACT S11). In a case in which it is determined that the commodity code is input (YES in ACT S11), the control section 100 determines whether or not the commodity code input in ACT S11 is an initially input commodity code of the commodity in this transaction (S12). In a case in which the commodity information of the commodity is not stored in the commodity information section 131, the control section 100 determines that the commodity code is initially input in this transaction.

In a case in which it is determined that the commodity code is initially input in this transaction (YES in S12), the control section 100 starts a face detection thread (program) shown in FIG. 9 (S13). Then, the control section 100 executes a sales registration processing on the commodity of which the commodity code is input in S11, and stores the commodity information in the commodity information section 131 (S14). Then, the control section 100 returns to the processing in S11. On the other hand, in a case in which it is determined that the commodity code is not initially input in this transaction (NO in S12), since the face detection thread has already been started, the control section 100 executes the processing in S14 without executing the processing in S13. After that, the control section 100 returns to the processing in S11.

Herein, the flow of the control processing of the face detection thread started in S13 by the control section 100 is described with reference to FIG. 9. The face detection thread is a program for capturing an image of the customer C who is positioned in front of the display section 19 for customer with the camera 191 arranged in the POS terminal 1 and detecting a face from the captured image.

In FIG. 9, the control section 100 activates the camera 191 to start image capturing (S41). Next, the control section 100 determines, with the use of the above-mentioned face detection technology, whether or not the face is detected from the image (captured by the camera 191) of the customer C who executes a transaction (S42). In a case in which it is determined that the face is detected (YES in S42), the control section 100 stores the facial image of the customer C who performs the transaction in the image storage section 132 (S43).

Next, the control section 100 determines whether or not the control section 100 outputs an under-mentioned end signal of the face detection thread (S44). In a case in which it is determined that the end signal of the face detection thread is output (YES in S44), the control section 100 stops the camera 191 to terminate the capturing operation by the camera 191 (S45).

Further, in a case in which it is determined in S44 that the end signal of the face detection thread is not output (NO in S44), the control section 100 returns to the processing in S42. Further, in a case in which it is determined in S42 that the face is not detected (NO in S42), the control section 100 executes the processing in S44 without executing the processing in S43.

Return to the description in FIG. 8, on the other hand, in a case in which it is determined in S11 that the commodity code is not initially input (NO in S11), the control section 100 declares the end of transaction, and determines whether or not the deposit/cash total key 171, which is used to carry out a settlement processing by cash for the transaction, is operated (S21). In a case in which it is determined that the deposit/cash total key 171 is operated (YES in S21), the control section 100 outputs an end signal for ending the face detection thread that is started in S13 (S22). Next, the control section 100 executes the settlement processing such as processing of deposit money received from the customer C or processing of dispensing change to the customer C (S23).

Next, the control section 100 determines whether or not the facial image is stored in the image storage section 132 (S24). In a case in which it is determined that the facial image is stored (YES in S24), since the face has already been detected, the control section 100 determines attributes (gender, age bracket and the like) of the customer C based on the facial image stored in the image storage section 132 (S25). In other words, the control section 100 compares the face part information stored in the face parts information section 1421 of the face master file 142 with each part (eyes, nose, mouth, ears, jaw, etc.) of the facial image of the customer C that is stored in the image storage section 132. Then, the control section 100 determines attributes of the customer C based on the comparative result. Specifically, the control section 100 determines the attribute the number of the face parts information of which most similar to those of the face image stored in the image storage section 132 is most. For example, in a case in which the eye information, the nose information, the mouth information and the ear information included in the face parts information of the face image stored in the image storage section 132 are similar to those of males in their forties, even if the jaw information included in the face parts information of the face image stored in the image storage section 132 is similar to that of males in the other age brackets, the control section 100 still determines that the attribute of the customer C is a male in his forties. In a case in which all the parts information (eyes, nose, mouth, ears, jaw, etc.) is similar to the face parts information of a male in his forties, the attribute of the customer C is determined as a male in his forties.

Next, the control section 100 stores attribute information indicating the attributes determined in S25 in association with the commodity information stored in the commodity information section 131 in the RAM 13 (S26). Then, the control section 100 sends the commodity information and the stored attribute information to the server 4 (S27). Then, the control section 100 clears the information in the commodity information section 131 and the image storage section 132 (S28). The information stored in an associated manner in the RAM 13 in S26 is also cleared.

On the other hand, in a case in which it is determined that the facial image is not stored in the image storage section 132 (NO in S24), the control section 100 reads out commodity information of all the commodities sales-registered in this transaction stored in the commodity information section 131 (S31). It is exemplified in the present embodiment that the customer C purchases three kinds of commodities (commodity A, commodity B and commodity C), and the description after S31 will be carried out aiming at three kinds of commodity information as needed. Then, the control section 100 adds three kinds of the read commodity information and starts an inquiry thread (S32). Then, the control section 100 associates the unknown information indicating that the attributes are unknown with three kinds of the read commodity information and stores them in the RAM 13 (S33). Next, the control section 100 sends the associated commodity information and the unknown information to the server 4 (S34). Then, the control section 100 executes a clear processing in S28. Further, in this case, it is not required to clear the associated information stored in the RAM 13 in S33. Furthermore, in a case in which it is determined in S21 that the deposit/cash total key 171 is not operated (NO in S21), the control section 100 returns to the processing in S11.

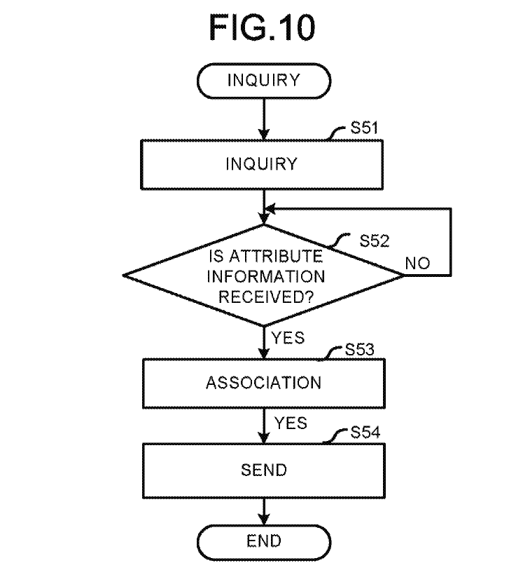

Next, the inquiry thread started in S32 is described with reference to FIG. 10. In FIG. 10, the control section 100 inquires of the server 4 about attributes based on the commodity information read out in S31 (S51). Next, the control section 100 determines whether or not the attribute information replying to the inquiry in S51 is received (S52). In a case in which it is determined that the attribute information is not received (NO in S52), the control section 100 waits for until the attribute information is received. In a case in which it is determined that the attribute information is received (YES in S52), the control section 100 associates the received attribute information with the commodity information read out in S31 (S53). In this case, the control section 100 replaces the unknown information associated with the commodity information with the received attribute information and associates the attribute information with the commodity information in S33. Then, the control section 100 stores the attribute information associated with the commodity information in the RAM 13. Sequentially, the control section 100 sends the stored attribute information associated with the commodity information to the server 4 (S54). Then, the control section 100 clears the associated information that is stored in the RAM 13.

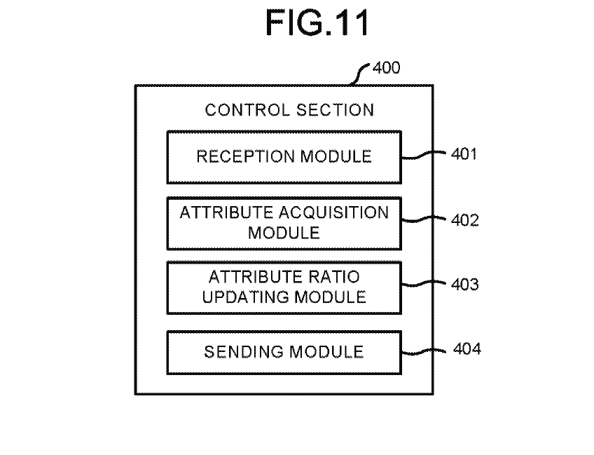

Sequentially, a control processing of the server 4 is described with reference to FIG. 11-FIG. 15. FIG. 11 is a functional block diagram illustrating the functional components of the server 4. The control section 400 functions as a reception module 401, an attribute acquisition section 402, an attribute ratio updating module 403 and a sending module 404 according to various programs including the control program 441 that is stored in the ROM 42 or the memory section 44.

The reception module 401 has a function of receiving commodity information of commodities purchased by a customer from the POS terminal 1 which executes a transaction processing on the commodities.

The attribute acquisition module 402 has a function of acquiring the attribute of which the attribute ratio is highest among the attribute ratios, stored in the storage section, which correspond to the commodity information received by the reception module 401.

The attribute ratio updating module 403 has a function of updating an attribute ratio stored in the storage section based on an attribute received by the reception module 401.

The sending module 404 has a function of sending attribute information indicating the attribute acquired by the attribute acquisition module 402 to the POS terminal 1.

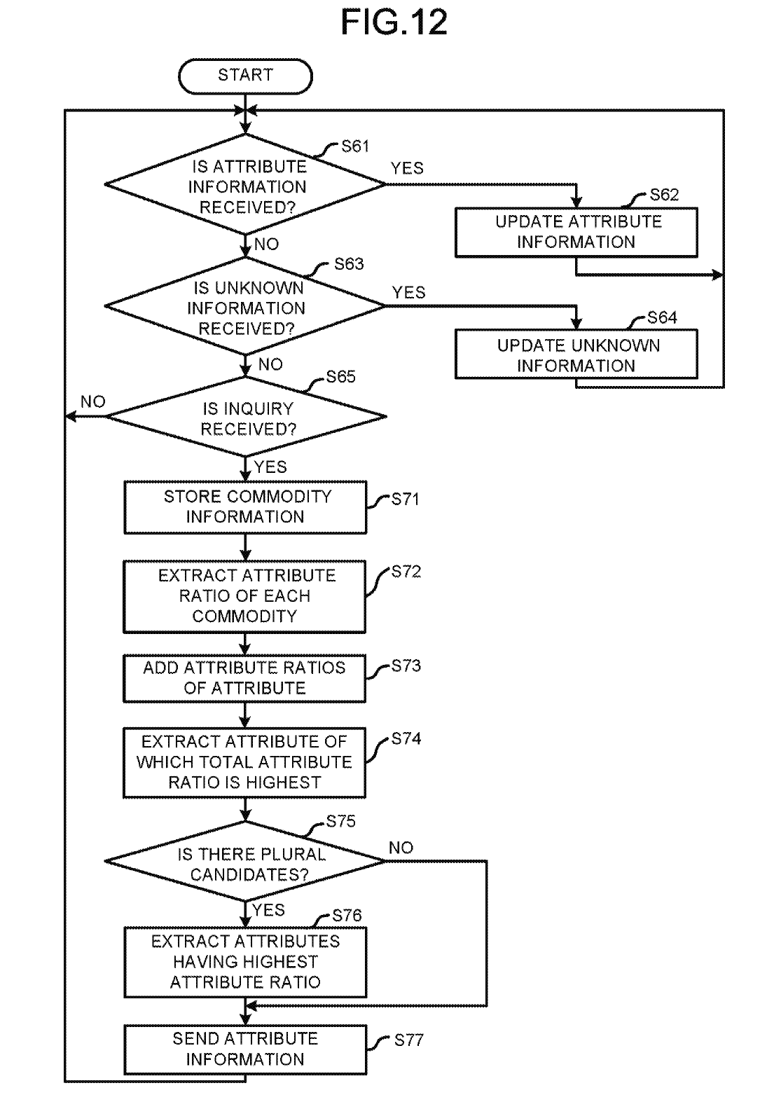

FIG. 12 is a flowchart illustrating the flow of the control processing of the server 4. In FIG. 12, the control section 400 (the reception module 401) determines whether or not the commodity information and the attribute information processed in the processing in S26 are received from the POS terminal 1 (S61). In a case in which it is determined that the commodity information and the attribute information are received (YES in S61), the control section 400 (the attribute ratio updating module 403) updates attribute ratios of all the attributes stored in the attribute storage section 442 and corresponding to the received commodity information and attribute information (S62). That is, among the purchase quantities of commodities stored respectively corresponding to the commodity information of the commodity A, the commodity B and the commodity C, the purchase quantity of the extracted attribute is increased by one, and a new attribute ratio is calculated. At this time, the control section 400 decreases the quantity of unknown information that is stored in the unknown information section 4423 of the attribute storage section 442 by one for the commodity information in which the attributes are stored in S64. Then, the control section 400 returns to the processing in S61.

Further, in a case in which it is determined that no attribute information is received from the POS terminal 1 (NO in S61), the control section 400 determines whether or not the unknown information processed in the processing in S33 is received from the POS terminal 1 (S63). In a case in which it is determined that the aforementioned unknown information is received (YES in S63), the control section 400 increases the quantity of the unknown information of the attributes, which corresponds to three kinds of the received commodity information and which is stored in the unknown information section 4423 of the attribute storage section 442, by one (S64). Then, the control section 400 returns to the processing in S61.

On the contrary, in a case in which it is determined that no unknown information is received from the POS terminal 1 (NO in S63), the control section 400 (the reception module 401) determines whether or not an inquiry signal of attributes in the processing in S32 and three kinds of commodity information are received from the POS terminal 1 (S65). In a case in which it is determined that they are received (YES in S65), the control section 400 stores the received three kinds of commodity information in the commodity information section 443 (S71). Then, based on three kinds of the commodity information stored in the commodity information section 443, the control section 400 extracts (acquires) the attribute ratio of each attribute corresponding to each kind of commodity information from the attribute ratio section 4422 (S72). Specifically, the control section 400 extracts the attribute ratio of each attribute corresponding to the commodity A from the attribute ratio section 4422. Further, the control section 400 extracts the attribute ratio of each attribute corresponding to the commodity B from the attribute ratio section 4422. Further, the control section 400 extracts the attribute ratio of each attribute corresponding to the commodity C from the attribute ratio section 4422.

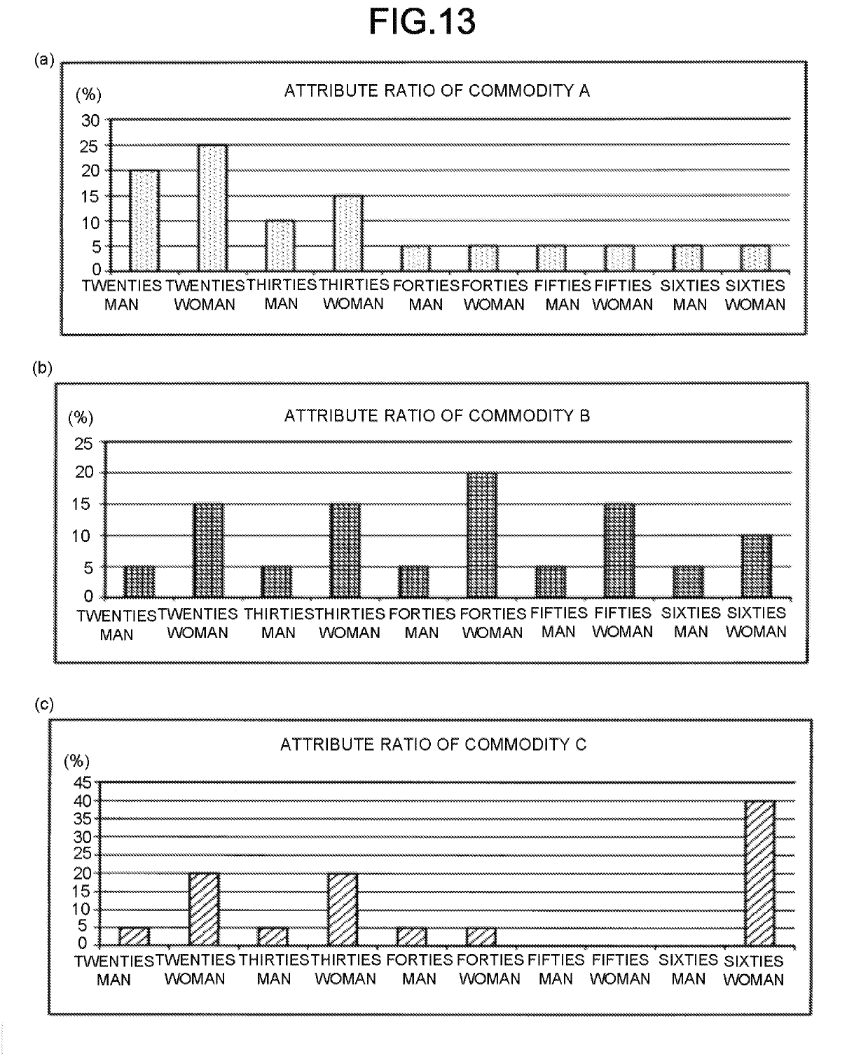

FIG. 13 is a bar graph indicating the attribute ratios of the attributes with respect to the commodity A, the commodity B and the commodity C that are extracted in S72. FIG. 13(a) is a bar graph indicating the attribute ratio of each attribute with respect to the commodity A. There is a tendency that the commodity A is mainly purchased by the attributes centering on males and females of younger generation. Further, FIG. 13(b) is a bar graph indicating the attribute ratio of each attribute with respect to the commodity B. There is a tendency that the commodity B is mainly purchased by the attributes centering on females of each generation. Further, FIG. 13(c) is a bar graph indicating the attribute ratio of each attribute with respect to the commodity C. There is a tendency that the commodity C is mostly purchased by a certain attribute (females in their sixties).

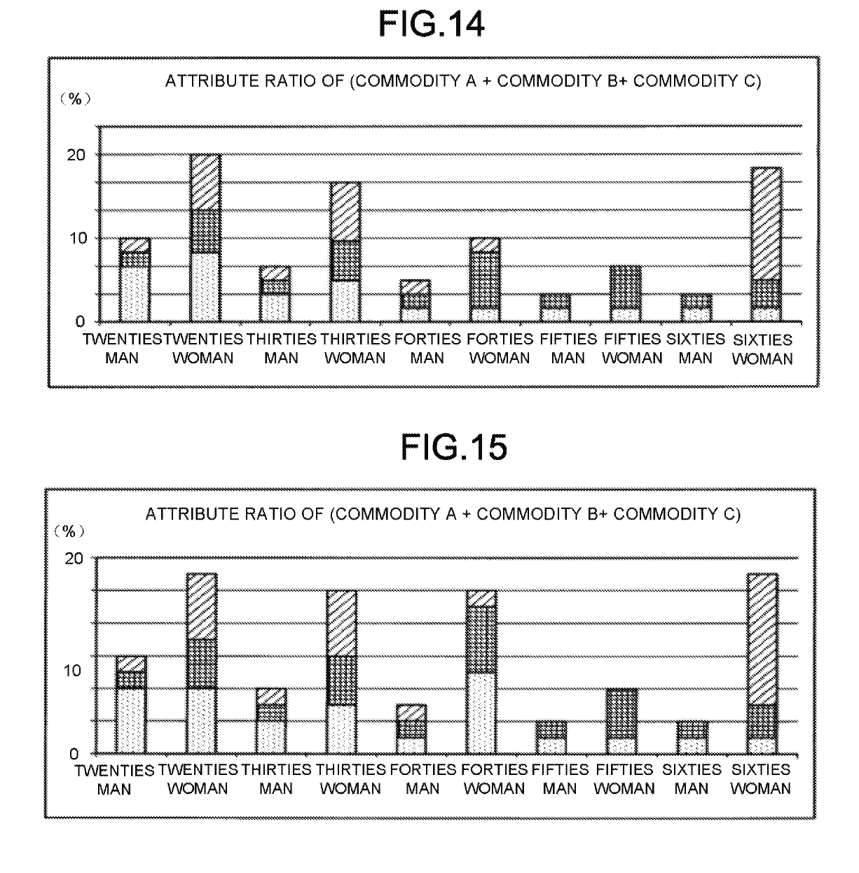

Next, the control section 400 adds the extracted attribute ratio of the attribute with respect to the commodity A, that with respect to the commodity B and that with respect to the commodity C to calculate the total attribute ratio (S73). FIG. 14 is a bar graph illustrating the total attribute ratio of each attribute with respect to the commodity A, the commodity B and the commodity C. The total attribute ratio of each attribute represents a ratio of the purchase of the commodities indicated by three kinds of the commodity information which are simultaneously purchases by a customer. That is, the larger the total attribute ratio is, the higher the tendency that people purchase three kinds of the commodities simultaneously is. In the graph in FIG. 14, it is aware that the attribute of the customers who simultaneously purchased most commodities indicated by three kinds of the commodity information in the past is females in their twenties of which the total attribute ratio is highest.

The control section 400 (the attribute acquisition module 402) extracts (acquires) the attribute of which the total attribute ratio is highest according to the calculated results in the processing in S73 (S74). Next, the control section 400 determines whether or not there is a plurality of attributes of which the total attribute ratios are highest according to the calculated results in the processing in S73 (S75).

FIG. 15 is a bar graph illustrating the total attribute ratio of each attribute with respect to the commodity A, the commodity B and the commodity C, similar to FIG. 14. In FIG. 15, there is a plurality of attributes of which the total attribute ratios are highest (females in their twenties and females in their sixties). In this case, the control section 400 determines that there is a plurality of attributes of which the total attribute ratios are highest.

In a case in which it is determined that there is a plurality of attributes of which the total attribute ratios are highest (YES in S75), the control section 400 extracts the attributes including an attribute ratio which is far higher than other attribute ratios with respect to one commodity (S76).

In FIG. 15, females in their twenties purchase the commodity A, the commodity B and the commodity C averagely. On the other hand, females in their sixties purchase more commodities C than the commodity A and the commodity B. As shown in FIG. 13(c), females in their sixties purchase the quantity of the commodities C more than twice as many as the quantity (which ranks second) of the commodities C purchased by females in their twenties. Thus, females in their sixties who purchases most commodities C are extracted.

In this way, in a case in which there is a plurality of attributes of which total attribute ratios are highest, the control section 400 extracts the attribute of females in their sixties who are most likely to purchase the commodity C.

Then, the control section 400 (the sending module 404) sends attribute information indicated by the attribute extracted in S76 to the POS terminal 1 (S77). The control section 100 of the POS terminal 1 executes the processing after S53 and clears the associated information stored in the RAM 13.

Further, in a case in which there is only one attribute of which total attribute ratio is highest (NO in S75), the control section 400 executes the processing in S77 without executing the processing in S76. Further, in a case in which it is determined in S65 that the attribute inquiry signal and three kinds of the commodity information are not received from the POS terminal 1 (NO in S65), the control section 400 returns to the processing in S61.

According to the embodiment described above, in a case in which the commodity information of commodities purchased by the customer C is received from the POS terminal 1, the control section 400 of the server 4 extracts an attribute of which attribute ratio is highest among the attribute ratios of the commodity purchased by customers in the past based on the commodity information. Thus, even if the face of the customer C who purchases the commodity cannot be detected by the POS terminal 1, it is also possible to extract the attribute information of the commodity. As a result, the server 4 can reduce the influence on that the face cannot be detected. According to the present embodiment, whether the customer C purchased only one commodity or many commodities, it is possible to extract attributes having high attribute ratios at the almost same precision.

Further, when receiving plural commodity information, the control section 400 extracts an attribute of which total attribute ratio obtained by adding the attribute ratios respectively corresponding to the different commodity information is highest. Consequently, even if the face of the customer C who purchases the commodity cannot be detected by the POS terminal 1, it is possible to acquire the attribute information of the attribute of the customer C who simultaneously purchases the commodities indicated by the plural commodity information. That is, the server 4 can reduce the influence on that the face cannot be detected.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is exemplified in the embodiment that the attribute ratio indicating a purchase rate of the commodity by an attribute (gender, age bracket and the like) of people who purchase the commodity is stored in the attribute ratio section 4422; however, the purchase quantity of the commodity by an attribute of people who purchase the commodity may be stored, instead of the purchase rate, as the attribute ratio.

Further, it is exemplified in the embodiment that, in a case in which unknown information indicating that the attributes are unknown and the commodity information are received, the quantity of the received unknown information is stored in association with the commodity information; however, it is not necessary to store the quantity of the received unknown information.

Further, it is exemplified in the embodiment that the attribute of which the total attribute ratio obtained by adding each attribute ratio of the same attribute is highest is extracted in S74; however, an attribute of which an average attribute ratio obtained by dividing a total value by the quantity of commodity is highest may be extracted.

Further, though it is exemplified in the present embodiment that the commodity is the sales object, the sales object is not limited to the commodity (for example, service).

Further, the program executed by the server 4 of the embodiment is recorded in a computer-readable recording medium such as CD-ROM, FD (flexible disk), CD-R, DVD (Digital Versatile Disk) in the form of installable or executable file to be provided.

In addition, the program executed by the server 4 of the embodiment may be stored in a computer connected with a network such as an Internet and downloaded through a network to be provided. The program executed by the server 4 of the embodiment may be provided or distributed via the network such as the Internet.

Alternatively, the program executed by the server 4 of the embodiment may be incorporated into a ROM and the like to be provided.

What is claimed is:

1. A server, comprising:
a storage section configured to store an attribute ratio representing the ratio of attributes of people who purchased a sales object in the past in association with sales object information specifying the sales object;
a reception module configured to receive the sales object information of the sales object purchased by a customer from a sales data processing apparatus which carries out a transaction processing of the sales object; and
an attribute acquisition module configured to acquire an attribute of which the attribute ratio is highest among the attribute ratios that are stored in the storage section and correspond to the sales object information received by the reception module.

2. The server according to claim 1, wherein
In a case in which the reception module receives plural sales object information at the same time, the attribute acquisition module acquires an attribute of which the sum of the attribute ratios is highest among the attribute ratios that are stored in the storage section.

3. The server according to claim 2, wherein
In a case in which there are plural attributes of which the sum of attribute ratios is the highest, the attribute acquisition module acquires an attribute including an attribute ratio that is far higher than other attribute ratios for one sales object.

4. The server according to claim 1, further comprising
An attribute ratio updating module configured to update the attribute ratio that is stored in the storage section based on the attribute received by the reception module.

5. The server according to claim 1, further comprising
a sending module configured to send attribute information indicating the attribute acquired by the attribute acquisition module to the sales data processing apparatus.

6. A method for acquiring attribute information, including:
receiving sales object information of a sales object purchased by a customer from a sales data processing apparatus which carries out a transaction processing of the sales object; and
acquiring an attribute of which the attribute ratio is highest among the attribute ratios which are stored in the storage section and correspond to the sales object information received by the reception module.
